(19) United States
(12) Patent Application Publication
(10) Pub. No.: US 2025/0202673 A1
(43) Pub. Date: Jun. 19, 2025

(54) WIRELESS COMMUNICATION DEVICE, WIRELESS COMMUNICATION TERMINAL, AND WIRELESS COMMUNICATION METHOD

(71) Applicant: SONY GROUP CORPORATION, TOKYO (JP)

(72) Inventors: RYUICHI HIRATA, TOKYO (JP); KEN TANAKA, TOKYO (JP); YUSUKE TANAKA, TOKYO (JP)

(21) Appl. No.: 18/846,288

(22) PCT Filed: Mar. 6, 2023
(86) PCT No.: PCT/JP2023/008229

§ 371 Date: Sep. 12, 2024

(30) Foreign Application Priority Data
Mar. 23, 2022 (JP) 2022-046400

(51) Int. Cl. H04L 5/14; H04W 72/0446

(52) U.S. Cl. CPC H04L 5/14; H04W 72/0446

(57) ABSTRACT

The present technology relates to a wireless communication device, a wireless communication terminal, and a wireless communication method capable of smoothly performing full duplex (FD) communication. The wireless communication device transmits a first signal to a wireless communication terminal using a first link and a second signal to the wireless communication terminal using a second link and performs, when transmitting the second signal, control in such a way as to include full duplex (FD) communication information, which is information necessary for another wireless communication terminal to perform FD communication using the first link, in the second signal and transmit the FD communication information. The present technology can be applied to a wireless communication system.

### TECHNICAL FIELD

The present technology relates to a wireless communication device, a wireless communication terminal, and a wireless communication method, and more particularly, to a wireless communication device, a wireless communication terminal, and a wireless communication method capable of smoothly performing full duplex (FD) communication.

### BACKGROUND ART

Wireless communication using a plurality of links (multi-link operation: MLO) has been studied as a method for coping with a requirement of high transmission speed such as 8K transmission or xReality (xR). A “link” is a wireless transmission path through which data can be transmitted between two wireless communication devices.

When MLO is performed, each link is selected from a plurality of mutually independent wireless transmission paths divided, for example, in a frequency domain.

A device that supports MLO is called a multi-link device (MLD). An MLD is a logical entity including two or more stations (STA: terminals), and has only one service access point (SAP) to a higher layer. An MLD in which each STA serves as an AP is called an AP MLD, and an MLD in which each STA serves as a non-AP STA, is called a non-AP MLD. Each entity in an MLD can be expressed as an AP belonging to an AP MLD (an AP affiliated with an AP MLD) or a non-AP STA belonging to a non-AP MLD (a non-AP STA affiliated with a non-AP MLD) to specify that it is an entity inside an MLD.

As a method for doubling frequency use efficiency in a single link or enabling immediate response, on the other hand, wireless communication (hereinafter referred to as full duplex (FD) communication) in which bidirectional communication is performed at the same frequency has been studied.

Patent Document 1 proposes a technique in which an AP that supports FD communication includes FD reception possibility information indicating whether or not reception through FD communication is possible in a downlink (DL) packet and transmits the DL packet.

### CITATION LIST

### Patent Document

Patent Document 1: WO 2019/138926 A

### SUMMARY OF THE INVENTION

### Problems to be Solved by the Invention

In the technique of Patent Document 1, however, a plurality of STAs that has received the FD reception possibility information might determine, on the basis of the FD reception possibility information, that an AP can receive data and transmit signals to the AP, and a reception failure might occur on an AP side.

Such a reception failure also occurs in a case where FD communication is performed using a link shared by an AP MLD and a non-AP MLD that support MLO.

The present technology has been made in view of such circumstances, and achieves stable FD communication.

### Solutions to Problems

A wireless communication device according to an aspect of the present technology includes a transmission unit that transmits a first signal to a wireless communication terminal using a first link and a second signal to the wireless communication terminal using a second link and a communication control unit that performs, when transmitting the second signal, control in such a way as to include full duplex (FD) communication information, which is information necessary for another wireless communication terminal to perform FD communication using the first link, in the second signal and transmit the FD communication information.

A wireless communication terminal according to a second aspect of the present technology includes a communication control unit that obtains, from a signal transmitted from a wireless communication device that performs communication using a first link and a second link, full duplex (FD) communication information, which is information necessary to perform FD communication using the first link, and that controls transmission through the FD communication on a basis of the FD communication information.

In the first aspect of the present technology, the first signal is transmitted to the wireless communication terminal using the first link, and the second signal is transmitted to the wireless communication terminal using the second link. When transmitting the second signal, control is performed in such a way as to include full duplex (FD) communication information, which is information necessary for another wireless communication terminal to perform FD communication using the first link, in the second signal and transmit the FD communication information.

In the second aspect of the present technology, the full duplex (FD) communication information, which is information necessary to perform FD communication using the first link, is obtained from the signal transmitted by the wireless communication device, which performs communication using the first link and the second link, and the transmission through the FD communication is controlled on the basis of the FD communication information.

### BRIEF DESCRIPTION OF DRAWINGS

FIG. 1 is a diagram illustrating a configuration example of a conventional first system.

FIG. 2 is a diagram illustrating a communication sequence of the conventional first system.

FIG. 3 is a diagram illustrating a configuration example of a conventional second system.

FIG. 4 is a diagram illustrating a communication sequence of the conventional second system.

FIG. 5 is a diagram illustrating a configuration example of a wireless communication system according to an embodiment of the present technology.

FIG. 6 is a block diagram illustrating a configuration example of a wireless communication device to which the present technology is applied.

FIG. 7 is a block diagram illustrating another configuration example of the wireless communication device to which the present technology is applied.

FIG. 8 is a diagram illustrating a flow of signals between MLDs in access control of FD communication according to a first embodiment of the present technology.

FIG. 9 is a diagram illustrating a sequence of the access control of FD communication according to the first embodiment in FIG. 8.

FIG. 10 is a diagram illustrating a configuration example of a PPDU including FD communication information in the present technology.

FIG. 11 is a diagram illustrating a configuration example of FD transmission information in the present technology.

FIG. 12 is a flowchart illustrating a process performed by an AP MLD.

FIG. 13 is a flowchart illustrating a process performed by a non-AP MLD.

FIG. 14 is a diagram illustrating a flow of signals between MLDs in access control of FD communication according to a second embodiment of the present technology.

FIG. 15 is a diagram illustrating a sequence of the access control of FD communication according to the second embodiment in FIG. 14.

FIG. 16 is a diagram illustrating a flow of signals between MLDs in access control of FD communication according to a third embodiment of the present technology.

FIG. 17 is a diagram illustrating a sequence of the access control of FD communication according to the third embodiment in FIG. 16.

FIG. 18 is a block diagram illustrating a configuration example of a computer.

### MODE FOR CARRYING OUT THE INVENTION

Modes for carrying out the present technology will be described hereinafter. The description will be given in the following order.
1. Conventional Technology
2. Configuration of Present Technology
3. First Embodiment
4. Second Embodiment
5. Third Embodiment
6. Others

### 1. Conventional Technology

### <Configuration of Conventional First System>

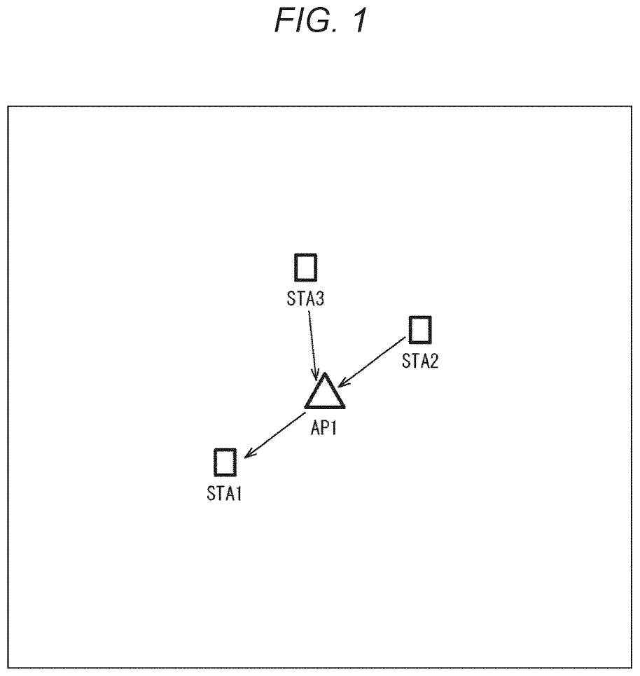

FIG. 1 is a diagram illustrating a configuration example of a conventional first system.

In FIG. 1, the first system includes AP1, which is one AP, and STA1 to STA3, which are three STAs.

Because AP1 supports FD communication, for example, AP1 can receive an uplink (UL) communication signal from STA2 or STA3 while transmitting a downlink (DL) communication signal to STA1.

### <Communication of Conventional First System>

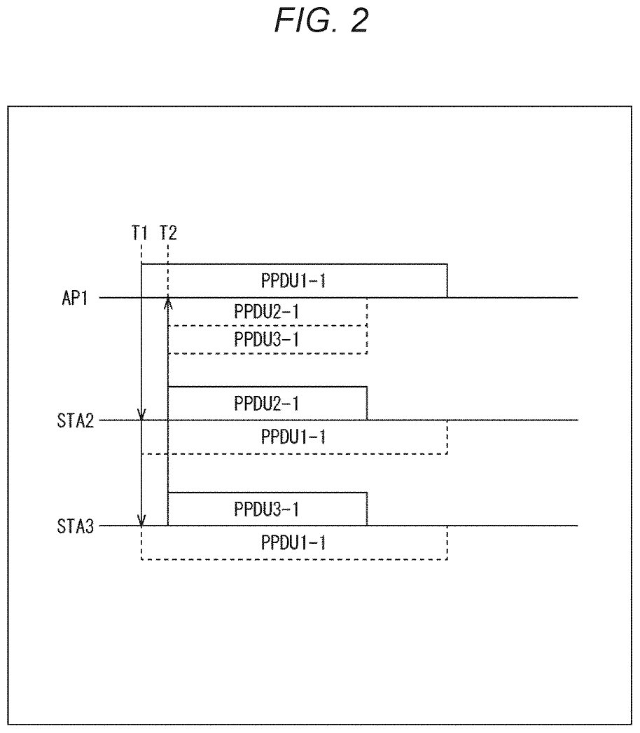

FIG. 2 is a diagram illustrating a communication sequence of the conventional first system.

In FIG. 2, solid rectangles indicate transmission of signals and broken rectangles indicate reception of signals. In addition, FIG. 2 does not illustrate operation of STA1. A horizontal axis in FIG. 2 represents time.

At a time T1, AP1 starts to transmit a DL communication signal PPDU1-1 to STA1. Similarly to STA1, which is not illustrated, STA2 and STA3 also start to receive the DL communication signal PPDU1-1. At this time, STA2 and STA3 other than STA1 can transmit signals to the AP.

STA2 or STA3, however, cannot perform carrier sensing due to an effect of the DL communication signal PPDU1-1 from the AP to STA1, and it is difficult to correctly detect a state of a channel desired to be used for transmission.

That is, STA2 and STA3 cannot detect a start of transmission by each other. At a time T2, therefore, STA2 starts to transmit an UL communication signal PPDU2-1 to AP1, and at the same time, STA3 undesirably starts to transmit an UL communication signal PPDU3-1 to AP1.

In this case, there is a possibility that AP1 cannot receive the signal UL communication signal PPDU2-1 from STA2 and the UL communication signal PPDU2-1 from STA3.

### <Configuration of Conventional Second System>

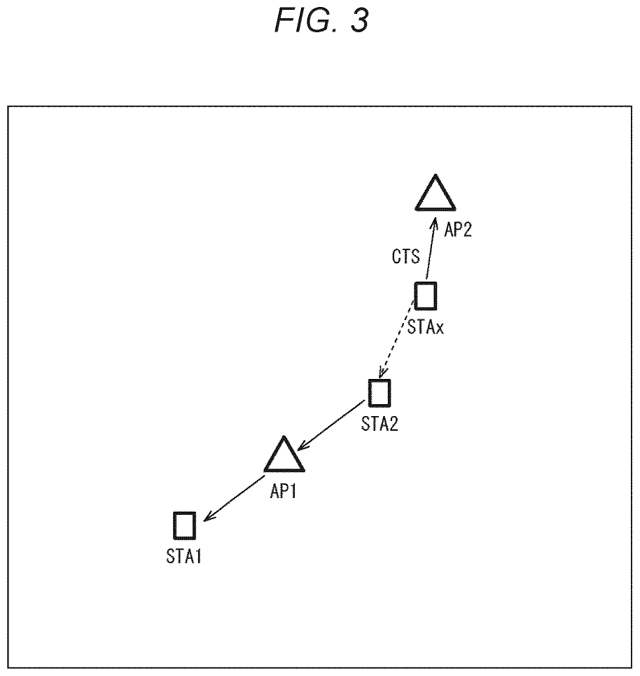

FIG. 3 is a diagram illustrating a configuration example of a conventional second system.

In FIG. 3, the second system includes two AP1 and AP2 and three STA1, STA2, and STAx.

Among these, AP1, STA1, and STA2 belong to the same basic service set (BSS; also called a cell), and AP2 and STAx belong to the same BSS.

Because AP1 supports FD communication, for example, AP1 can receive an UL communication signal from STA2 while transmitting a DL communication signal to STA1. Although STA2 and STAx belong to different BSSs, STA2 and STAx are located close enough to each other to communicate signals with each other.

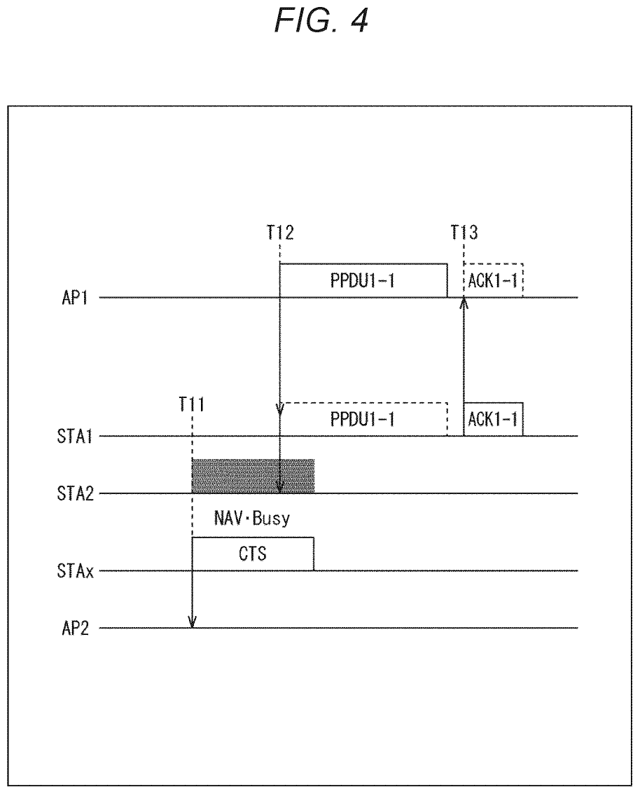

FIG. 4 is a diagram illustrating a communication sequence of the conventional second system.

In FIG. 4, as in FIG. 2, solid rectangles indicate transmission of signals and broken rectangles indicate reception of signals.

At a time T11, STAx starts to transmit a clear to send (CTS) to AP2.

STA2 belongs to a BSS different from one to which STAx belongs, but is located close to STAx. While STAx is transmitting the CTS, therefore, STA2 is in a busy state.

At a time T12 while STAx is transmitting the CTS, AP1 starts to transmit a DL communication signal PPDU1-1 to STA1. STA1 starts to receive the DL communication signal PPDU1-1.

When the transmission by AP1 is completed, STA1 starts to transmit, at a time T13, an UL communication signal ACK1-1 to AP1. AP1 starts to receive the UL communication signal ACK1-1.

When AP1 is transmitting the DL communication signal PPDU1-1 to STA1 in the above communication sequence, STA2 other than STA1 can transmit a signal to AP1 in practice since AP1 supports FD communication.

In a case where STA2 attempts to transmit a UL communication signal to AP1 while AP1, which supports FD communication, is transmitting a DL communication signal to STA1, however, STA2 needs to receive an immediate response included in the signal transmitted from AP1 to STA1. By receiving the immediate response, STA2 can adjust a transmission end time so that two operations of transmission or two operations of reception do not occur at the same time, and confirm that interference caused by transmission thereby does not affect a destination terminal of AP1 during transmission.

As illustrated in FIG. 4, however, in a case where STA2 enters the busy state due to the CTS transmitted from STAx, which is a terminal belonging to a different BSS, to AP2, it is difficult for STA2 to correctly decode the signal transmitted from AP1 to STA1.

In a case where STA2 has failed to obtain information from AP1 due to an effect of a signal from a different BSS or the like, STA2 thus cannot determine whether or not FD communication can be started, and loses an opportunity to transmit an UL communication signal.

As described above, the transmission failure illustrated in FIG. 2 or the loss of a transmission opportunity illustrated in FIG. 4 might occur even in a case where FD communication is performed with a link shared by an AP MLD and a non-AP MLD that support MLO.

In the present technology, therefore, in a case where a first signal is transmitted to a wireless communication terminal using a first link and a second signal is transmitted to the wireless communication terminal using a second link, FD communication information, which is information necessary for another wireless communication terminal to perform FD communication using the first link, is included in the second signal when the second signal is transmitted.

Details of the present technology will be described hereinafter.

### 2. Configuration of Present Technology

### Configuration Example of Wireless Communication System

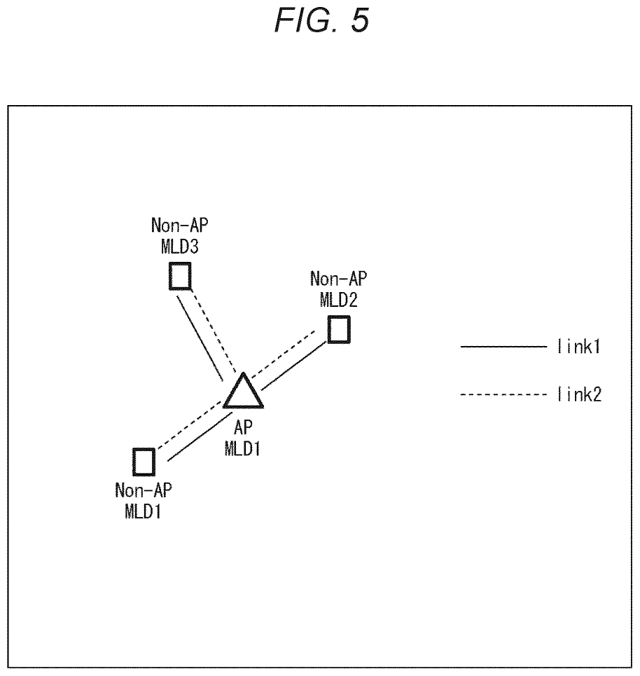

FIG. 5 is a diagram illustrating a configuration example of a wireless communication system according to an embodiment of the present technology.

In the wireless communication system of FIG. 5, data is communicated through wireless communication using a plurality of links (MLO).

When MLO is performed, each link is selected from a plurality of mutually independent wireless transmission paths divided, for example, in a frequency domain. As each link, for example, a channel selected from a plurality of channels included in one of frequency bands such as a 2.4 GHz band, a 5 GHz band, a 6 GHz band, and a 920 MHz band is used.

As described above, a device corresponding to MLO is called an MLD. An MLD is a logical entity including two or more STAS, and has only one SAP to an upper layer.

The wireless communication system of FIG. 5 includes AP MLD1, which is one AP MLD, and non-AP MLD1 to non-AP MLD3, which are three non-AP MLDs. Non-AP MLD1 to non-AP MLD3 are connected to AP MLD1.

In FIG. 5, solid lines connecting AP MLD1 and non-AP MLD1 to non-AP MLD3 to each other represent link1 (first links), and broken lines connecting AP MLD1 and non-AP MLD1 to non-AP MLD3 to each other represent link2 (second links).

AP MLD1 is a wireless communication device that operates as a base station that supports MLO. Non-AP MLD1 to non-AP MLD3 are wireless communication devices that operate as terminals that support MLO.

AP MLD1 communicates with non-AP MLD1 to non-AP MLD3 using link1 and link2.

Here, AP MLD1 is a wireless communication device that supports FD communication. For this reason, for example, AP MLD1 can receive data from non-AP MLD2 or non-AP MLD3 using link1 while transmitting data to non-AP MLD1 using link1 and link2. AP MLD1 can receive data from the other of non-AP MLD2 and non-AP MLD3 using link2 while transmitting data to non-AP MLD1 using link1 and link2.

Non-AP MLD1 to non-AP MLD3 will be described hereinafter as wireless communication devices that do not support FD communication, but may be wireless communication devices that support FD communication.

Note that link1 and link2 may be two channels selected from the same frequency band or two channels selected from different frequency bands.

In addition, the number of links used between the AP MLD and each non-AP MLD is not limited to two. For example, three or more links may be used, instead. In addition, the number of non-AP MLDs is not limited to three, and may be two, or four or more, instead.

### <Configuration of Device>

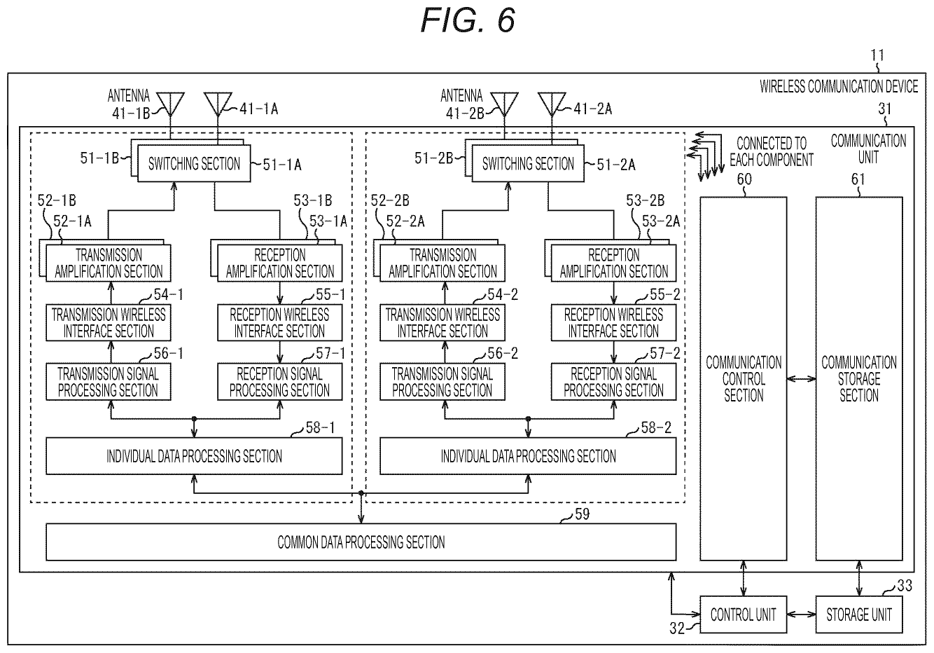

FIG. 6 is a block diagram illustrating a configuration example of a wireless communication device to which the present technology is applied.

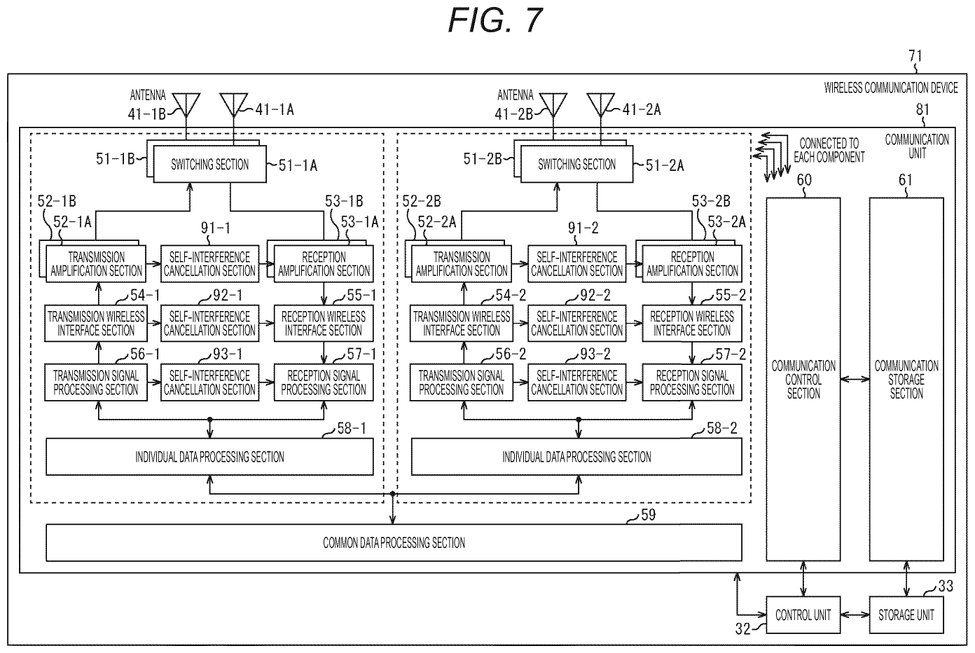

A wireless communication device 11 illustrated in FIG. 6 is a wireless communication device that operates as an MLD that does not support FD communication. Each non-AP MLD of FIG. 5 is the wireless communication device 11 illustrated in FIG. 6 or a wireless communication device 71 of FIG. 7 that supports FD communication, which will be described later.

The wireless communication device 11 includes a communication unit 31, a control unit 32, a storage unit 33, an antenna 41-1A, an antenna 41-1B, an antenna 41-2A, and an antenna 41-2B. In a case where it is not necessary to distinguish the antenna 41-1A, the antenna 41-1B, the antenna 41-2A, and the antenna 41-2B, each antenna will be generically referred to as an antenna 41.

The communication unit 31 transmits and receives data. The communication unit 31 includes a switching section 51-1A, a switching section 51-1B, a switching section 51-2A, a switching section 51-2B, a transmission amplification section 52-1A, a transmission amplification section 52-1B, a transmission amplification section 52-2A, a transmission amplification section 52-2B, a reception amplification section 53-1A, a reception amplification section 53-1B, a reception amplification section 53-2A, and a reception amplification section 53-2B.

The communication unit 31 includes a transmission wireless interface section 54-1, a transmission wireless interface section 54-2, a reception wireless interface section 55-1, and a reception wireless interface section 55-2.

The communication unit 31 includes a transmission signal processing section 56-1, a transmission signal processing section 56-2, a reception signal processing section 57-1, and a reception signal processing section 57-2.

In addition, the communication unit 31 includes an individual data processing section 58-1, an individual data processing section 58-2, a common data processing section 59, a communication control section 60, and a communication storage section 61.

Note that in a case where it is not necessary to distinguish the switching section 51-1, the switching section 51-2, the switching section 51-1, and the switching section 51-2, each switching section will be referred to as a switching section 51. In a case where it is not necessary to distinguish the transmission amplification section 52-1A, the transmission amplification section 52-1B, the transmission amplification section 52-2A, and the transmission amplification section 52-2B, each transmission amplification section will be referred to as a transmission amplification section 52. In a case where it is not necessary to distinguish the reception amplification section 53-1A, the reception amplification section 53-1B, the reception amplification section 53-2A, and the reception amplification section 53-2B, each reception amplification section will be referred to as a reception amplification section 53.

In addition, in a case where it is not necessary to distinguish the transmission wireless interface section 54-1 and the transmission wireless interface section 54-2 and the reception wireless interface section 55-1 and the reception wireless interface section 55-2, each transmission wireless interface section and each reception wireless interface section will be referred to as a transmission wireless interface section 54 and a reception wireless interface section 55, respectively.

In a case where it is not necessary to distinguish the transmission signal processing section 56-1 and the transmission signal processing section 56-2 and the reception signal processing section 57-1 and the reception signal processing section 57-2, each transmission signal processing section and each reception signal processing section will be referred to as a transmission signal processing section 56 and a reception signal processing section 57, respectively. In a case where it is not necessary to distinguish the individual data processing section 58-1 and the individual data processing section 58-2, each individual data processing section will be referred to as an individual data processing section 58.

The switching section 51 connects the antenna 41 and the transmission amplification section 52 or the reception amplification section 53 to each other by switching between the transmission amplification section 52 and the reception amplification section 53 in a time-division manner.

At a time of transmission, the transmission amplification section 52 amplifies power of an analog signal supplied from the transmission wireless interface section 54 to certain power and outputs the analog signal with the amplified power to the antenna 41.

At a time of reception, the reception amplification section 53 amplifies power of an analog signal supplied from the antenna 41 to certain power and outputs the analog signal with the amplified power to the reception wireless interface section 55.

A subset of functions of the transmission amplification section 52 may be included in the transmission wireless interface section 54. A subset of functions of the reception amplification section 53 may be included in the reception wireless interface section 55. In addition, a subset of the functions of the transmission amplification section 52 and the reception amplification section 53 may be embodied as a component outside the communication unit 31.

At the time of transmission, the transmission wireless interface section 54 converts a transmission symbol stream from the transmission signal processing section 56 into an analog signal and performs filtering, up-conversion into a carrier frequency, and phase control. The transmission wireless interface section 54 outputs the analog signal after the phase control to the transmission amplification section 52.

At the time of reception, the reception wireless interface section 55 performs phase control, down-conversion, and inverse filtering on an analog signal supplied from the reception amplification section 53. After the inverse filtering, the reception wireless interface section 55 outputs a reception symbol stream, which is a result of the conversion into a digital signal to the reception signal processing section 57.

At the time of transmission, the transmission signal processing section 56 performs encoding, interleaving, modulation, and the like on a data unit supplied from the individual data processing section 58. The transmission signal processing section 56 outputs a transmission symbol stream obtained by adding a physical header to the modulated data to each transmission wireless interface section 54.

At the time of reception, the reception signal processing section 57 analyzes a physical header of a reception symbol stream supplied from each reception wireless interface section 55 and performs demodulation, deinterleaving, decoding, and the like on the reception symbol stream to generate a data unit. The generated data unit is output to the individual data processing section 58.

Note that the transmission signal processing section 56 and the reception signal processing section 57 perform complex channel characteristic estimation and spatial separation as necessary.

At the time of transmission, the individual data processing section 58 performs a channel access operation based on carrier sensing, addition of a MAC header and an error detection code to data to be transmitted, and coupling of a plurality of data units.

At the time of reception, the individual data processing section 58 performs decoupling of a MAC header of a received data unit, an analysis, error detection, and a retransmission request operation.

At the time of transmission, the common data processing section 59 performs sequence management of data held by the communication storage section 61 and control information and management information received from the communication control section 60. In addition, the common data processing section 59 performs encryption of the control information and the management information and the like to generate a data unit, and allocates the generated data unit to the individual data processing sections 58-1 and 58-2.

At the time of reception, the common data processing section 59 performs an analysis and reordering on a data unit.

The antennas 41, the switching sections 51, the transmission amplification sections 52, the reception amplification sections 53, the transmission wireless interface section 54, the reception wireless interface section 55, the transmission signal processing section 56, the reception signal processing section 57, and the individual data processing section 58 form a set (hereinafter also referred to as an individual communication set or an entity) for each block defined by a broken line.

In a case where the wireless communication device 11 is an AP MLD, an individual communication set is an AP. In a case where the wireless communication device 11 is a non-AP MLD, an individual communication set is a non-AP STA.

Each set is a component of the wireless communication device 11 and performs wireless communication using a corresponding link. In addition, the storage unit 33 may be included in each set.

Note that the operation of the individual data processing section 58 and the common data processing section 59 is not limited to the operation described above, and, for example, one may perform the operation of the other. For example, the individual data processing section 58 may be defined such that all the functions of the common data processing section 59 are performed for each individual communication set.

In addition, the links used by the individual sets may have different frequency bands. In addition, the transmission signal processing section 56, the reception signal processing section 57, and the individual data processing section 58 may form a set for each block defined by a broken line, and two sets of these, or three or more sets of these, may be connected to one transmission wireless interface section 54 and one reception wireless interface section 55, instead.

The communication control section 60 controls the operation of each component of the communication unit 31 and transmission of information between the components. In addition, the communication control section 60 transfers control information and management information to be transmitted to another wireless communication device to the individual data processing section 58 and the common data processing section 59.

In particular, in the present technology, the communication control section 60 controls each component in such a way as to transmit, using a link, FD transmission information regarding transmission through another link that is being used for FD communication.

The communication storage section 61 holds information to be used by the communication control section 60. In addition, the communication storage section 61 holds data to be transmitted and received data.

The control unit 32 includes a central processing unit (CPU), a read only memory (ROM), a random access memory (RAM), and the like. The control unit 32 executes a program stored in the ROM or the like and controls the communication unit 31 and the communication control section 60. In addition, the control unit 32 may also perform part of the operation of the communication control section 60, instead. In addition, the communication control section 60 and the control unit 32 may be configured as one block.

The storage unit 33 holds information to be used by the communication unit 31 and the control unit 32. In addition, the storage unit 33 may also perform part of the operation of the communication storage section 61, instead. The storage unit 33 and the communication storage section 61 may be configured as one block.

Note that the communication unit 31 is achieved by one or more LSIs.

In addition, the configuration of the communication unit 31 is an example and is not limited to this. For example, there might be a case where the communication unit 31 includes three or more individual communication sets. In a case where the communication unit 31 includes three or more individual communication sets, some of the plurality of individual communication sets might share the same antenna 41 via a frequency division unit.

FIG. 7 is a block diagram illustrating another configuration example of the wireless communication device to which the present technology is applied.

The wireless communication device 71 illustrated in FIG. 7 is a wireless communication device that operates as an MLD that supports FD communication. The AP MLD of FIG. 5 includes the wireless communication device 71 of FIG. 7 that supports FD communication.

The wireless communication device 71 is different from the wireless communication device 11 of FIG. 6 in that the communication unit 31 is replaced by a communication unit 81. Note that, in FIG. 7, the same components as in FIG. 6 are given the same reference numerals.

The communication unit 81 is different from the communication unit 31 of FIG. 6 in that a self-interference cancellation section 91-1, a self-interference cancellation section 91-2, a self-interference cancellation section 92-1, a self-interference cancellation section 92-2, a self-interference cancellation section 93-1, and a self-interference cancellation section 93-2 are added.

In a case where it is not necessary to distinguish the self-interference cancellation section 91-1 and the self-interference cancellation section 91-2, the self-interference cancellation section 92-1 and the self-interference cancellation section 92-2, and the self-interference cancellation section 93-1 and the self-interference cancellation section 93-2, each self-interference cancellation section will be referred to as a self-interference cancellation section 91, a self-interference cancellation section 92, or a self-interference cancellation section 93.

The self-interference cancellation section 91 is disposed between the transmission amplification section 52 and the reception amplification section 53.

The self-interference cancellation section 92 is disposed between the transmission wireless interface section 54 and the reception wireless interface section 55.

The self-interference cancellation section 93 is disposed between the transmission signal processing section 56 and the reception signal processing section 57.

The self-interference cancellation sections 91 to 93 operate in such a way as to subtract self-interference in each component on a reception side on the basis of a transmission signal of each component on a transmission side.

Note that not all the three self-interference cancellation sections 91 to 93 need not necessarily be provided, and it is only required that at least one of these be provided. In addition, there may be a block where the self-interference cancellation sections 91 to 93 (a group of the series of components from the individual data processing section 58 to the antenna 41) are not included.

In addition, in the case of FIG. 7, in particular, the communication control section 60 controls each component in such a way as to transmit FD communication information, which is information necessary for non-AP MLDs to perform FD communication, using a plurality of links.

### 3. First Embodiment

### <Flow of Signals in Access Control of FD Communication>

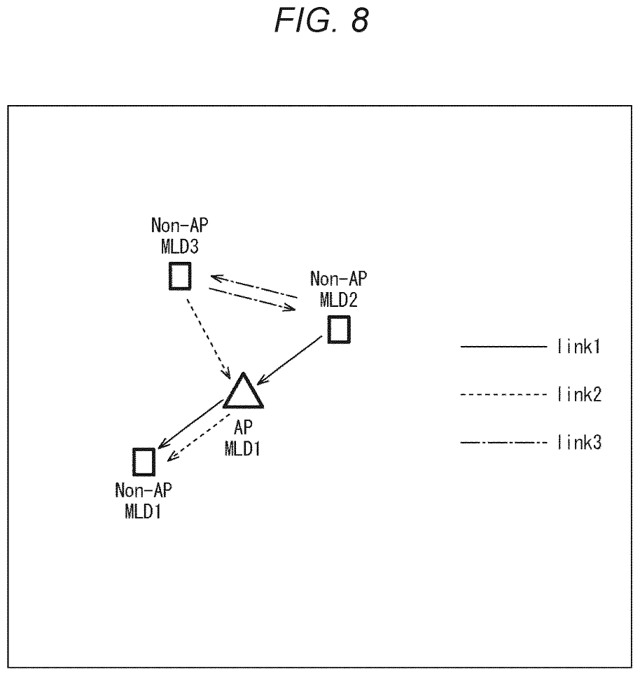

FIG. 8 is a diagram illustrating a flow of signals between MLDs in access control of FD communication according to the first embodiment of the present technology.

FIG. 8 illustrates an example where access control of FD communication is performed using a plurality of links in a case where non-AP MLD1 to non-AP MLD3 are connected to AP MLD1. AP MLD1 is an MLD that supports FD communication. Non-AP MLD1 to non-AP MLD3 are MLDs that do not support FD communication.

Note that a solid-line arrow indicates a connection through link1 between AP MLD1 and each of non-AP MLD1 to non-AP MLD3. A broken-line arrow indicates a connection through link2 between AP MLD1 and each of non-AP MLD1 to non-AP MLD3. A dash-dot-line arrow indicates a connection through link3 between non-AP MLD2 and non-AP MLD3.

In FIG. 8, AP MLD1 transmits signals to non-AP MLD1 through FD communication using link1 and link2. Non-AP MLD1 receives signals transmitted from AP MLD1 using link1 and link2.

The signal transmitted from AP MLD1 using link2 includes FD communication information regarding link1 and link2, which is information necessary for FD communication through link1 and link2. Non-AP MLD2 and non-AP MLD3 also receive the FD communication information.

In addition, AP MLD1 receives signals transmitted from non-AP MLD2 through FD communication using link1. AP MLD1 receives signals transmitted from non-AP MLD3 through FD communication using link2.

Non-AP MLD2 transmits signals to AP MLD1 through FD communication using link1 on the basis of the FD communication information regarding link1 and link2. At this time, non-AP MLD2 transmits, to non-AP MLD3 using the link3, FD transmission information regarding link1, which is information regarding transmission of signals through FD communication using link1. In addition, non-AP MLD2 receives FD transmission information regarding link2 transmitted from non-AP MLD3.

Non-AP MLD3 receives FD transmission information regarding link1 transmitted from non-AP MLD2. Non-AP MLD3 transmits signals to AP MLD1 through FD communication using link2 on the basis of the FD communication information regarding link1 and link2 and the FD transmission information regarding link1. At this time, non-AP MLD3 transmits FD transmission information regarding link2 to non-AP MLD2 using link3.

### <Sequence of Access Control of FD Communication>

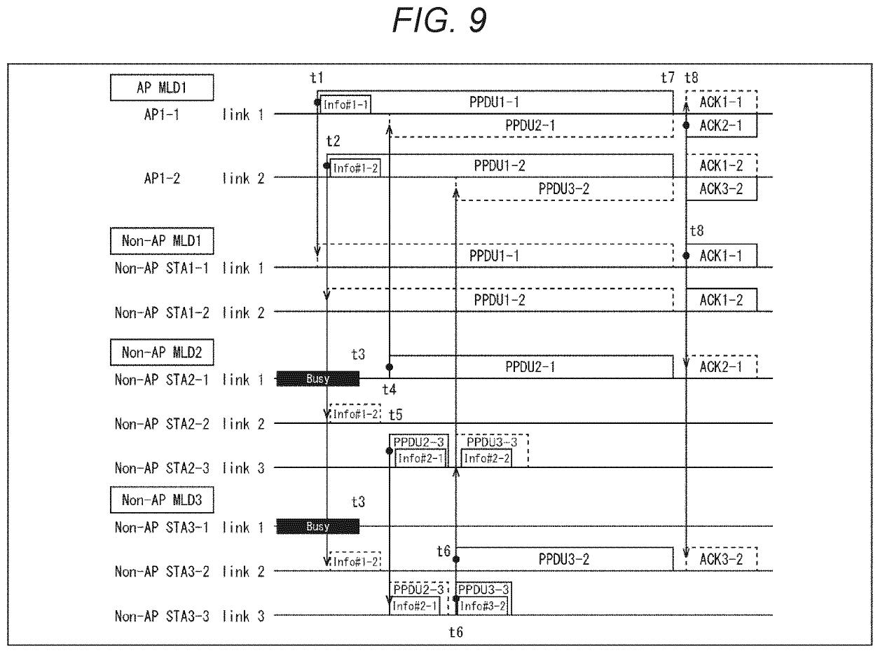

FIG. 9 is a diagram illustrating a sequence of the access control of FD communication according to the first embodiment in FIG. 8.

In FIG. 9, among entities of AP MLD1, an entity that operates with link1 is represented as AP1-1, and an entity that operates with link2 is represented as AP1-2. Among entities of non-AP MLD1, an entity that operates with link1 is represented as non-AP STA1-1, and an entity that operates with link2 is represented as non-AP STA1-2.

Among entities of non-AP MLD2, an entity that operates with link1 is represented as non-AP STA2-1, and an entity that operates with link2 is represented as non-AP STA2-2. Among entities of non-AP MLD3, an entity that operates with link1 is represented as non-AP STA3-1, and an entity that operates with link2 is represented as non-AP STA3-2.

In addition, in FIG. 9, solid-line squares indicate transmission of a signal, and broken-line squares indicate reception of a signal. Note that FIG. 8 will be referred to as appropriate in the following description with reference to FIG. 9. Note that these similarly apply to the following diagrams illustrating sequences.

AP MLD1 transmits PPDU1-1 through FD communication using link1 at a time t1, and transmits PPDU2-1 through FD communication using link2 at a time t2. Note that PPDU1-1 and PPDU2-1 are transmitted at different times in FIG. 9 because transmission rights for link1 and link2 are often acquired at different times, but PPDU1-1 and PPDU2-1 may be transmitted at the same time. In addition, PPDU1-1 and PPDU2-1 include different data, but may include the same data, instead.

PPDU1-1 includes FD communication information Info #1-1 regarding link1. PPDU2-1 includes FD communication information Info #1-2 regarding link1 and link2. The FD communication information Info #1-1 describes, as information regarding link1, that, for example, non-AP STA1-1, non-AP STA2-1, and non-AP STA3-1 are an FD link pair. In addition, the FD communication information Info #1-2 describes, as the information regarding link1 described above and the information regarding link2, that non-AP STA1-2, non-AP STA2-2, and non-AP STA3-2 are an FD link pair. Furthermore, the FD communication information Info #1-1 and the FD communication information Info #1-2 describe that, for example, link3 is used for access control between non-AP STAS.

An FD link pair represents a pair of terminals capable of FD communication. For example, in a case where communication is not affected even if non-AP STA2-1 starts UL transmission while AP1-1 is transmitting a signal to non-AP STA1-1, non-AP STA1-1 and non-AP STA2-1 become an FD link pair. Non-AP STA2-1 starting UL transmission without affecting communication is, for example, a case where interference with reception by non-AP STA1-1 is equal to or less than a certain level.

Non-AP MLD1 receives PPDU1-1 using link1 and receives PPDU2-1 using link2. Non-AP MLD2 and non-AP MLD3, on the other hand, cannot receive PPDU1-1 using link1 because link1 is in a busy state due to an effect of a signal from another BSS or the like. Non-AP MLD2 and non-AP MLD3 instead receive the FD communication information #Info1-2 in PPDU2-1 using link2.

At a time t3, link1 of non-AP MLD2 and non-AP MLD3 is released from the busy state.

Among non-AP MLD2 and non-AP MLD3 that have received the FD communication information Info #1-2, non-AP MLD2 acquires (not illustrated) a right to transmit PPDU2-3 using link3 at a time t4, and starts transmission of PPDU2-1 to AP1 through FD communication using link1.

At a time t5 during transmission of PPDU2-1 using link1, non-AP MLD2 transmits PPDU2-3 including the FD transmission information Info #2-1 regarding link1 to non-AP MLD3 using link3. Non-AP MLD3 receives PPDU2-3 using link3.

Non-AP MLD3 that has received PPDU2-3 transmits, at a time t6, PPDU3-2 to AP MLD1 through FD communication using link2 instead of link1 used by non-AP MLD2 for transmission to AP MLD1 on the basis of the FD transmission information Info #2-1 regarding link1. At this time, non-AP MLD3 transmits PPDU3-3 describing FD transmission information #Info3-2 regarding link2 to non-AP MLD2 using link3.

At a time t7, the transmission of all of PPDU1-1, PPDU1-2, PPDU2-1, and PPDU3-2 is completed.

At a time t8, AP MLD1 transmits ACK2-1 to non-AP MLD2 through FD communication using link1 and transmits ACK3-1 to non-AP MLD3 through FD communication using link2. In addition, non-AP MLD1 transmits ACK1-1 to AP MLD1 through FD communication using link1 and transmits ACK1-2 to AP MLD2 through FD communication using link2.

At this time, in order to reduce interference with ACK2-1 and ACK3-2, non-AP MLD1 may transmit ACK1-1 and ACK1-2 with transmission power specified by AP MLD1 in the FD communication information #Info1-1 and the FD communication information #Info1-2.

Note that in a case where there is non-AP MLD4 capable of performing FD transmission to AP MLD1 in FIG. 9, non-AP MLD4 does not perform transmission through FD communication due to reception of PPDU2-3 and PPDU3-3 of AP MLD1.

### Configuration Example of PPDU Including FD Communication Information in Present Technology

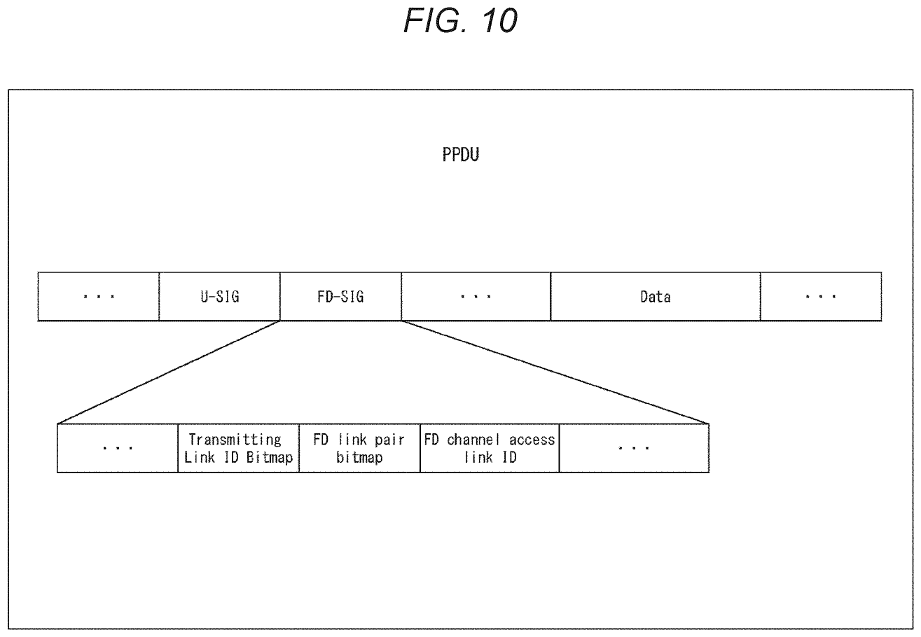

FIG. 10 is a diagram illustrating a configuration example of a PPDU including FD communication information in the present technology.

In the PPDU of FIG. 10, FD-SIG including the FD communication information is disposed after U-SIG (Universal SIG) in a header portion. Note that description of the FD communication information in the PPDU is indicated by a PHY Version Identifier field (not illustrated) in U-SIG.

FD-SIG includes at least Transmitting Link ID bitmap, FD link pair bitmap, and FD channel access link ID.

Transmitting Link ID bitmap is information indicating, in FD-SIG, a link with which an AP MLD is transmitting the PPDU.

FD link pair bitmap is information indicating an FD link pair. That is, FD link pair bitmap is information indicating a non-AP STA that can perform transmission through FD communication during the transmission of the PPDU.

FD channel access link ID is information indicating a link with which a non-AP MLD to which the non-AP STA belongs performs channel access in order for the non-AP STA to perform transmission through FD communication.

### <Configuration of FD Transmission Information in Present Technology>

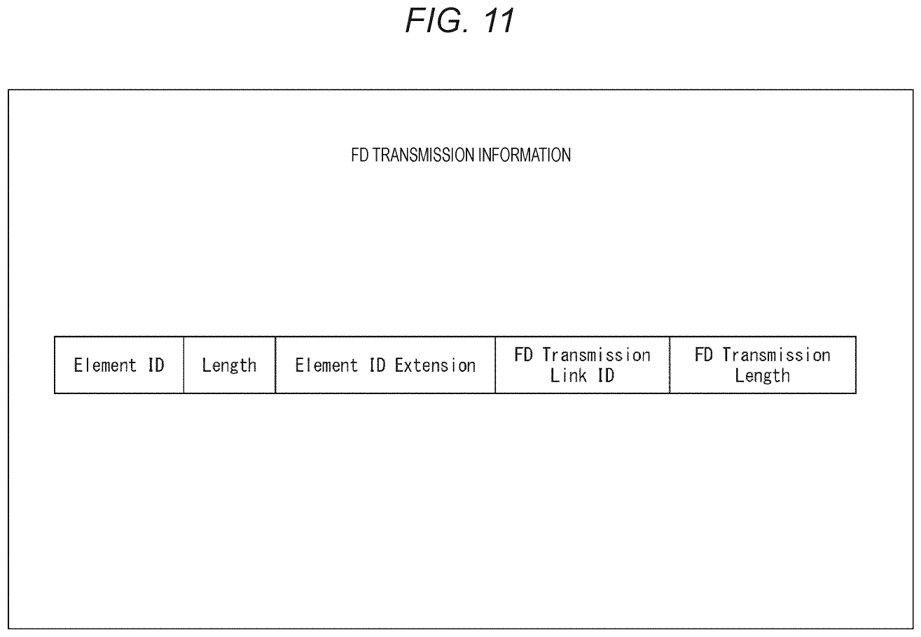

FIG. 11 is a diagram illustrating a configuration example of FD transmission information in the present technology.

In FIG. 11, the FD transmission information is defined as an element.

The FD transmission information includes fields of Element ID, Element ID Extension, length, FD Transmission Link ID, and FD Transmission Length.

Element ID and Element ID Extension include identification information for identifying that the element is an element in which information regarding transmission through FD communication is described.

Length includes information regarding length of the element.

The FD Transmission Link ID field includes information regarding a link with which a corresponding device is performing transmission through FD communication.

The FD Transmission Length field includes information regarding time length of transmission through FD communication performed by the corresponding device.

The FD transmission information configured as an element as described above is not necessarily included in a PPDU and transmitted as illustrated in FIG. 11, and may be described, for example, in FD-SIG of a PPDU described above with reference to FIG. 10 and transmitted, instead.

### <Process Performed by AP MLD1>

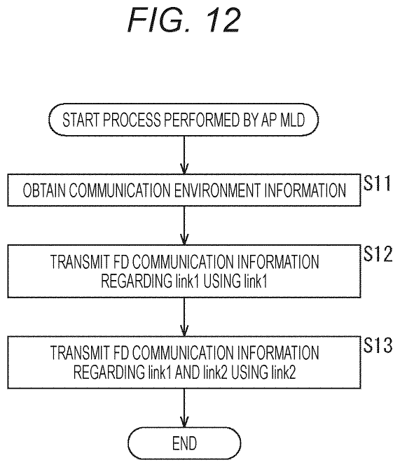

FIG. 12 is a flowchart illustrating a process performed by an AP MLD.

Note that the process of FIG. 12 is performed when the communication control section 60 of the wireless communication device 71 that operates as the AP MLD controls each component of the communication unit 81.

In step S11, the communication control section 60 of the AP MLD obtains communication environment information from nearby terminals.

The obtained communication environment information includes FD link pairs, each of which indicates a pair of terminals capable of FD communication, path loss information between terminals, interference information between terminals, information indicating self-interference cancellation capability of the AP MLD, operation information regarding the AP MLD and non-AP MLDs, information indicating whether or not the non-AP MLDs support FD communication, and the like.

The information indicating the self-interference cancellation capability of the AP MLD may be indicated as the amount of self-interference at a time of transmission with maximum transmission power.

The operation information regarding the AP MLD and the non-AP MLDs is information indicating whether the AP MLD and the non-AP MLDs operate as a simultaneous transmit and receive (STR) link pair or a non-STR link pair.

The STR link pair is a link pair in which there is no restriction when signals are simultaneously transmitted and received between links, such as when leakage power between links does not affect communication quality. The Non STR link pair is a link pair in which there is a restriction when signals are simultaneously transmitted and received between links.

In step S12, the communication control section 60 transmits PPDU1-1 including FD communication information regarding link1 using link1 (the time t1 in FIG. 9).

The FD communication information includes, for example, current transmission power information, reception power information (target receive power) receivable during PPDU transmission, an MCS receivable during PPDU transmission, and a destination terminal (an MAC address or STA ID) of a PPDU.

The FD communication information includes, for example, a link (in FIG. 9, link3) with which channel access control for FD transmission between non-AP MLDs is performed, an end time of the PPDU (i.e. time length of the PPDU), and a start time at which a non-AP STA may transmit a frame using link3.

The FD communication information includes, for example, a non-AP MLD (FD link pair) with which transmission can be performed using link1 or link2, an available MCS and target RSS, transmission power when the non-AP MLD sends an Ack, information (Transmitting Link ID) regarding a link used by the AP MLD for transmission, and the like.

Note that the non-AP MLD with which transmission can be performed using link1 or link2 is a non-AP MLD that hardly affects reception by other non-AP MLDs even if data is transmitted while the other non-AP MLDs are receiving data.

In addition, information regarding a plurality of links with which channel access control for transmission through FD communication is performed may be included in the FD communication information.

Furthermore, the AP MLD may get a transmission opportunity in advance by performing a frame exchange between an RTS and a CTS using the non-AP MLD and link3 so that the non-AP MLD can perform channel access control for transmission through FD communication.

By including the start time at which the non-AP STA may transmit a frame using link3 in the FD communication information, it is possible to ensure that all MLDs complete switching of link3.

In step S13, the communication control section 60 transmits PPDU1-2 including FD communication information regarding link1 and link2 using link2 (the time t2 in FIG. 9). The transmission process then ends.

Note that the end time of the PPDU in the FD communication information regarding link1 may be transmitted in accordance with whether or not control (end time alignment) for aligning, between link1 and link2, transmission end times for PPDUs transmitted by the AP MLD is being performed.

### <Process Performed by Non-AP MLD>

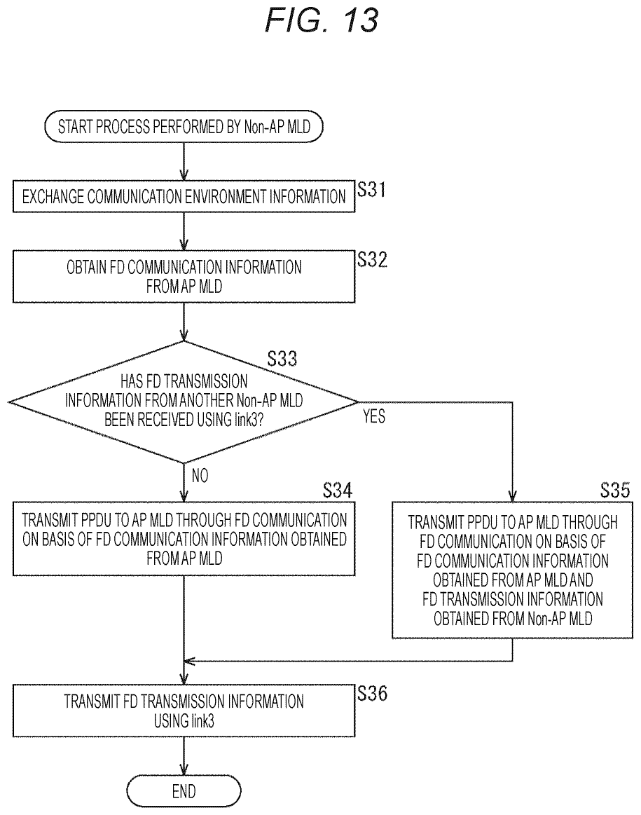

FIG. 13 is a flowchart illustrating a transmission process performed by a non-AP MLD.

Note that the process of FIG. 13 is performed when the communication control section 60 of the wireless communication device 11 that operates as the non-AP MLD controls each component of the communication unit 31.

In step S31, the communication control section 60 of the non-AP MLD obtains communication environment information from nearby terminals.

PPDU1-2 including FD communication information regarding link1 and link2 is transmitted from an AP MLD (the time t2 in FIG. 9).

In step S32, the communication control section 60 obtains the FD communication information regarding link1 and link2 from the transmitted PPDU1-2.

Note that at this time, the communication control section 60 determines whether or not link3 is enabled by referring to a link (link3 in FIG. 9) with which channel access control is performed between non-AP MLDs in the FD communication information regarding link1 and link2, and makes link3 enabled if link3 is not enabled.

In step S33, the communication control section 60 determines whether or not FD transmission information from another non-AP MLD has been received using link3.

If it is determined in step S33 that FD transmission information from another non-AP MLD has not been received using link3, the process proceeds to step S34.

In step S34, the communication control section 60 performs transmission through FD communication on the basis of the FD communication information obtained from the AP MLD.

Note that the determination of transmission based on the FD communication information is performed as follows.

For example, when a destination of transmission (referred to as a transmission destination) by the AP MLD is a terminal in an FD link pair, it is determined that transmission through FD communication is possible. At this time, transmission through FD communication is performed such that an ACK will be received when SIFS has elapsed after a transmission end time of the AP MLD.

In addition, in a case where FD communication information has not been received using link1 or link2, it is determined that transmission through FD communication is not possible. In a case where FD communication information can be obtained from the AP MLD using one of the links and the transmission destination set by the AP MLD is an FD link pair, on the other hand, it is determined that transmission through FD communication can be performed using link1 and link2.

For example, the communication control section 60 may determine the amount of interference on an AP MLD side from transmission power of the AP MLD and self-interference capability information regarding the AP MLD in the FD communication information, and set transmission power thereof on the basis of path loss information between an AP and a STA so that a certain SNR is achieved on an AP side.

In addition, the communication control section 60 may specify and transmit a transmission start time for an ACK at a time of transmission through FD communication such that the ACK will be received when the SIFS has elapsed after the transmission end time of the AP MLD.

For example, PPDU3-2 including FD transmission information of PPDU2-1 is transmitted from non-AP MLD2 using link3 (the time t5 in FIG. 9). In this case, it is determined in step S33 that FD transmission information from another non-AP MLD has been received using link3, the process proceeds to step S35.

In step S35, the communication control section 60 determines whether or not to perform transmission through FD communication on the basis of the FD communication information obtained from the AP MLD and the FD transmission information obtained from the non-AP MLD, and performs the transmission through FD communication. As described above, FD transmission information includes at least information (FD transmission Link ID) indicating a link used for transmission and transmission time length (FD transmission length).

Note that a transmission process through FD communication based on FD transmission information is performed after determining at least one of transmission time length and a link as follows.

The communication control section 60 does not perform transmission through FD communication until, for example, a time indicated by transmission time length of a non-AP MLD described in FD transmission information. The communication control section 60 transmits PPDU3-1 through, for example, FD communication using a link different from one used for transmission by the non-AP MLD described in the FD transmission information.

After step S34 or S35, the process proceeds to step S36.

In step S36, the communication control section 60 transmits FD transmission information of PPDU3-1 using link3 (the time t6 in FIG. 9). The process of FIG. 13 then ends.

### 4. Second Embodiment

### <Flow of Signals in Access Control of FD Communication>

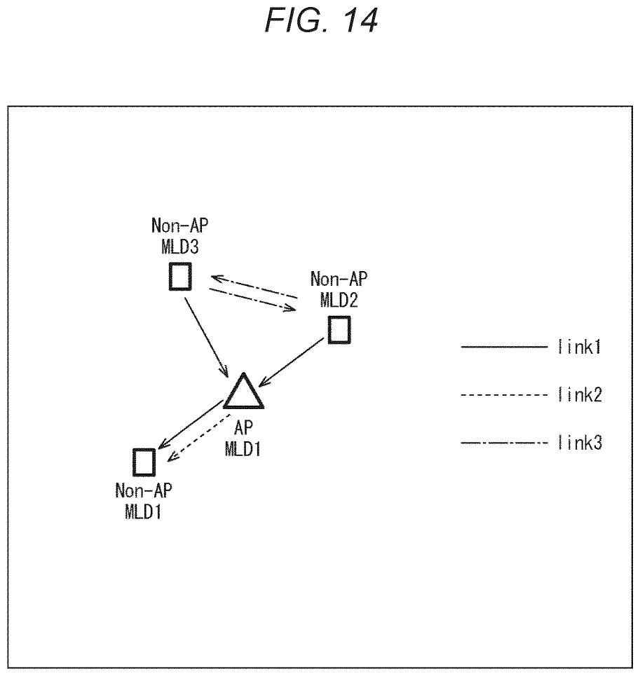

FIG. 14 is a diagram illustrating a flow of signals between MLDs in access control of FD communication according to a second embodiment of the present technology.

FIG. 14 is the same as FIG. 8 in that non-AP MLD1 to non-AP MLD3 are connected to AP MLD1. FIG. 14 is different from FIG. 8 in that access control of FD communication is performed using a single link instead of a plurality of links.

In FIG. 14, AP MLD1 transmits signals to non-AP MLD1 through FD communication using link1 and link2. Non-AP MLD1 receives signals transmitted from AP MLD1 using link1 and link2.

The signal transmitted from AP MLD1 using link2 includes FD communication information regarding link1 and link2. The FD communication information regarding link1 and link2 is also received by non-AP MLD2 and non-AP MLD3.

AP MLD1 receives a signal transmitted from non-AP MLD2 through FD communication using link1. AP MLD1 receives a signal transmitted from non-AP MLD3 through FD communication using link2.

Non-AP MLD2 transmits a signal to AP MLD1 through FD communication using link1 on the basis of the FD communication information regarding link1 and link2. At this time, non-AP MLD2 transmits FD transmission information regarding link1 to non-AP MLD3 using link3. In addition, non-AP MLD2 receives FD transmission information regarding link1 transmitted from non-AP MLD3.

Non-AP MLD3 receives FD transmission information regarding link1 transmitted from non-AP MLD2. Non-AP MLD3 can find, on the basis of the FD communication information regarding link1 and link2 and the FD transmission information regarding link1, that a signal transmitted by non-AP MLD2 using link1 is short and transmission of a signal desired to be transmitted thereby ends before the transmission of the signal transmitted by AP MLD1 using link1 ends.

Non-AP MLD3, therefore, transmits the signal to AP MLD1 through FD communication using link1 after the transmission by non-AP MLD2 using link1 is completed. At this time, non-AP MLD3 transmits FD transmission information regarding link to non-AP MLD2 using link3.

### <Sequence of Access Control of FD Communication>

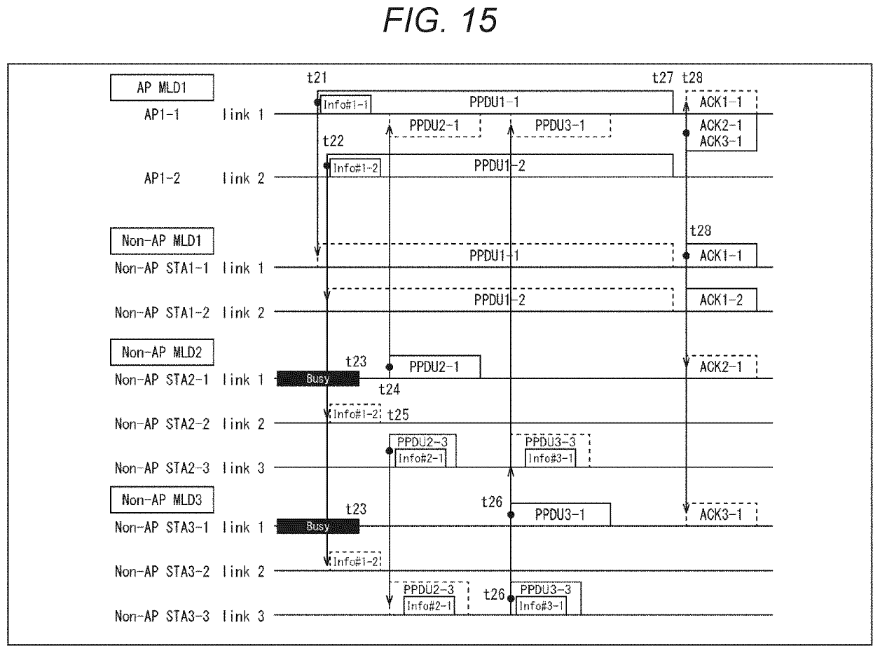

FIG. 15 is a diagram illustrating a sequence of the access control of FD communication according to the second embodiment in FIG. 14.

AP MLD1 transmits PPDU1-1 through FD communication using link1 at a time t21, and transmits PPDU2-1 through FD communication using link2 at a time t22.

PPDU1-1 includes FD communication information Info #1-1 regarding link1. PPDU2-1 includes FD communication information Info #1-2 regarding link1 and link2. In FIG. 15, the FD communication information Info #1-1 and the FD communication information Info #1-2 describe, as information regarding link1, that, for example, non-AP STA1-1, non-AP STA2-1, and non-AP STA3-1 are an FD link pair. Furthermore, the FD communication information Info #1-1 and the FD communication information Info #1-2 describe that, for example, link3 is used for access control between non-AP STAs.

Times t23 to t25 in FIG. 15 are basically similar to the times t3 to t5 in FIG. 8, and description thereof is omitted.

Non-AP MLD3 that has received PPDU2-3 waits until a transmission end time for PPDU2-1 on the basis of the FD transmission information Info #2-1 regarding link2 at a time t26, and then transmits PPDU3-1 to AP MLD1 through FD communication using link1. At this time, non-AP MLD3 transmits PPDU3-3 describing FD transmission information Info #3-1 regarding link1 to non-AP MLD2 using link3.

At a time t27, the transmission of all of PPDU1-1, PPDU1-2, and PPDU3-1 is completed.

At a time t28, AP MLD1 transmits ACK2-1 to non-AP MLD2 through FD communication using link1 and transmits ACK3-1 to non-AP MLD3 through FD communication using link1. In addition, non-AP MLD1 transmits ACK1-1 to AP MLD1 through FD communication using link1 and transmits ACK1-2 to AP MLD2 through FD communication using link2.

At this time, in order to reduce interference with ACK2-1 and ACK3-1, non-AP MLD1 may transmit ACK1-1 and ACK1-2 with transmission power specified by AP MLD1 in the FD communication information Info #1-1 and the FD communication information Info #1-2.

Note that in a case where there is non-AP MLD4 capable of performing FD transmission to AP MLD1 in FIG. 15 as in FIG. 9, non-AP MLD4 does not perform transmission through FD communication due to reception of PPDU2-3 and PPDU3-3 of AP MLD1.

### 5. Third Embodiment

### <Flow of Signals in Access Control of FD Communication>

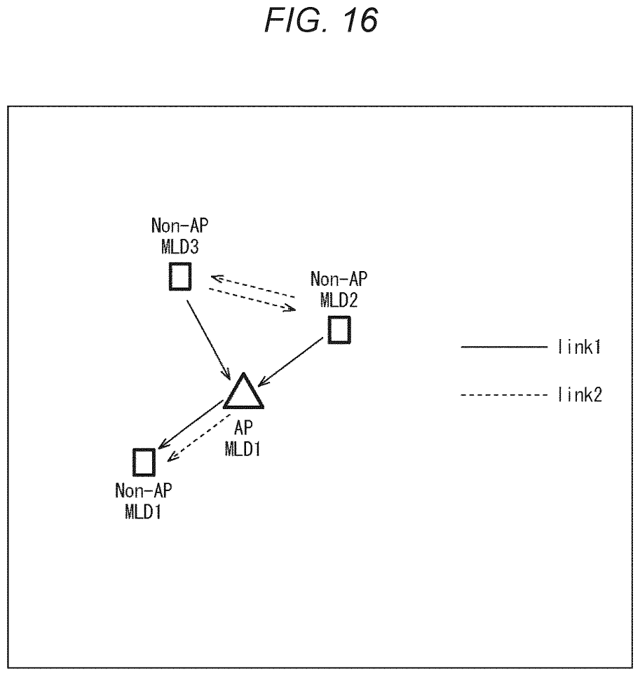

FIG. 16 is a diagram illustrating a flow of signals between MLDs in access control of FD communication according to a third embodiment of the present technology.

FIG. 16 is the same as FIG. 8 in that non-AP MLD1 to non-AP MLD3 are connected to AP MLD1. FIG. 16 is different from FIG. 8 in that all MLDs perform access control of FD communication using two links.

In FIG. 16, AP MLD1 transmits a signal to non-AP MLD1 through FD communication using link1. Non-AP MLD1 receives the signal transmitted from AP MLD1 using link1.

The signal transmitted from AP MLD1 using link1 includes FD communication information regarding link1. Non-AP MLD2 and non-AP MLD3 also receive the FD communication information.

AP MLD1 receives a signal transmitted from non-AP MLD2 through FD communication using link1.

Non-AP MLD2 transmits signals to AP MLD1 through FD communication using link1 on the basis of the FD communication information regarding link1. At this time, non-AP MLD2 transmits FD transmission information regarding link1 to non-AP MLD3 using link2. In addition, non-AP MLD2 receives FD transmission information regarding link1 transmitted from non-AP MLD3 using link2.

Non-AP MLD3 receives FD transmission information regarding link1 transmitted from non-AP MLD2. Non-AP MLD3 can find, on the basis of the FD communication information regarding link1 and the FD transmission information regarding link1, that a signal transmitted by non-AP MLD2 using link1 is short and transmission of a signal desired to be transmitted thereby ends before the transmission of the signal transmitted by AP MLD1 using link1 ends.

Non-AP MLD3, therefore, transmits the signal to AP MLD1 through FD communication using link1 after the transmission by non-AP MLD2 using link1 is completed. At this time, non-AP MLD3 transmits FD transmission information regarding link1 to non-AP MLD2 using link2.

### <Sequence of Access Control of FD Communication>

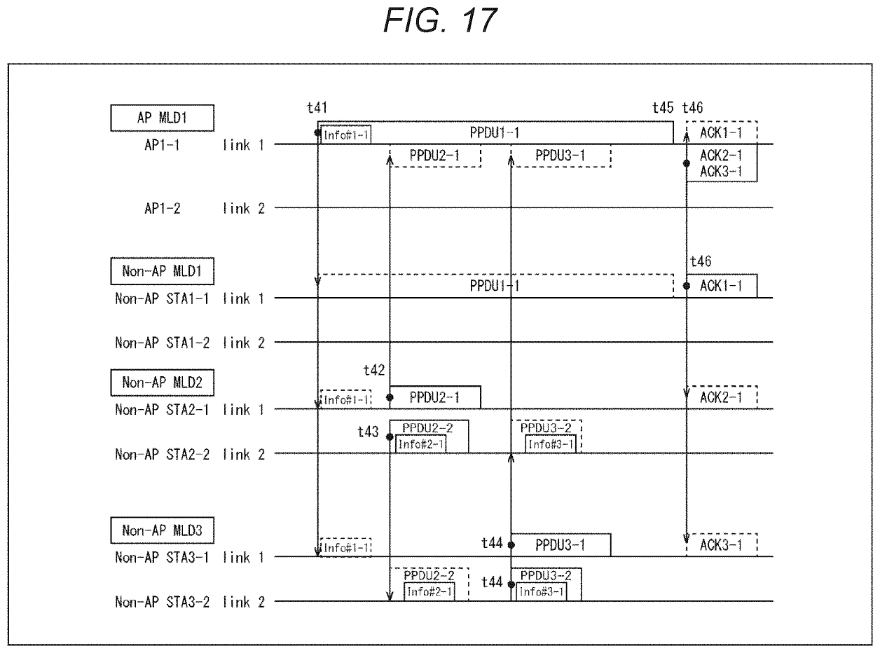

FIG. 17 is a diagram illustrating a sequence of the access control of FD communication according to the third embodiment in FIG. 16.

AP MLD1 transmits PPDU1-1 through FD communication using link1 at a time t41.

PPDU1-1 includes FD communication information Info #1-1 regarding link1. In FIG. 17, the FD communication information describes, as information regarding link1, that, for example, non-AP STA1-1, non-AP STA2-1, and non-AP STA3-1 are an FD link pair. Furthermore, the FD communication information describes, for example, that link2 is used for access control between non-AP STAS.

Non-AP MLD1 receives PPDU1-1 using link1. Non-AP MLD2 and non-AP MLD3, on the other hand, receive the FD communication information Info #1-1 in PPDU2-1 using link1.

Among non-AP MLD2 and non-AP MLD3 that have received the FD communication information Info #1-1, non-AP MLD2 acquires (not illustrated) a right to transmit PPDU2-3 using link2 at a time t42, and starts transmission of PPDU2-1 to AP1 through FD communication using link1.

At a time t43 during transmission of PPDU2-1 using link1, non-AP MLD2 transmits PPDU2-3 including the FD transmission information Info #2-1 regarding link1 to non-AP MLD3 using link2. Non-AP MLD3 receives PPDU2-3 using link2.

Non-AP MLD3 that has received PPDU2-3 waits until a transmission end time for PPDU2-1 on the basis of the FD transmission information Info #1-1 regarding link1 at a time t44, and then transmits PPDU3-1 to AP MLD1 through FD communication using link1. At this time, non-AP MLD3 transmits PPDU3-3 describing FD transmission information #Info3-1 regarding link1 to non-AP MLD2 using link2.

At a time t45, the transmission of all of PPDU1-1 and PPDU3-1 is completed.

At a time t46, AP MLD1 transmits ACK2-1 to non-AP MLD2 through FD communication using link1 and transmits ACK3-1 to non-AP MLD3 through FD communication using link1. In addition, non-AP MLD1 transmits ACK1-1 to AP MLD1 through FD communication using link1.

At this time, in order to reduce interference with ACK2-1 and ACK3-1, non-AP MLD1 may transmit ACK1-1 with transmission power specified by AP MLD1 in the FD communication information Info #1-1.

Note that in a case where there is non-AP MLD4 capable of performing FD transmission to AP MLD1 in FIG. 17 as in FIG. 9, non-AP MLD4 does not perform transmission through FD communication due to reception of PPDU2-3 and PPDU3-3 of AP MLD1.

### 6. Others

### <Effects of Present Technology>

As described above, in the present technology, an AP MLD transmits a first signal to non-AP MLD1 using link1 (first link) and transmits a second signal to non-AP MLD1 using link2 (second link). And when the second signal is transmitted, control is performed in which full duplex (FD) communication information, which is information necessary for non-AP MLD2 to perform FD communication using link1, is included in the second signal and transmitted.

As a result, since a non-AP MLD that has not obtained the FD communication information regarding link1 transmitted from the AP MLD using link1 can also obtain the FD communication information regarding link1 from the second signal transmitted using link2, it is possible to determine whether or not to perform transmission to the AP MLD through FD communication.

In addition, in the present technology, full duplex (FD) communication information, which is information necessary to perform FD communication using the first link, is obtained from a signal transmitted by a wireless communication device, which performs communication using the first link and the second link, and transmission through FD communication is controlled on the basis of the FD communication information.

In addition, in a case where a plurality of non-AP MLDs obtains FD communication information transmitted from an AP MLD and becomes simultaneously able to perform transmission through FD communication, the non-AP MLDs perform access control using link3 (third link). Even in a case where a use state of a link with which FD communication is performed cannot be detected, therefore, the FD communication can be performed without collision of signals from the plurality of non-AP MLDs.

As described above, even in a case where FD communication is performed using a link shared by an AP MLD and non-AP MLDs that support MLO, the FD communication can be smoothly performed.

### Configuration Example of Computer

The series of processing steps described above can be executed by hardware and also can be executed by software. In a case where the series of processing steps is executed by software, a program included in the software is installed from a program recording medium on a computer incorporated in dedicated hardware, a general-purpose personal computer, or the like.

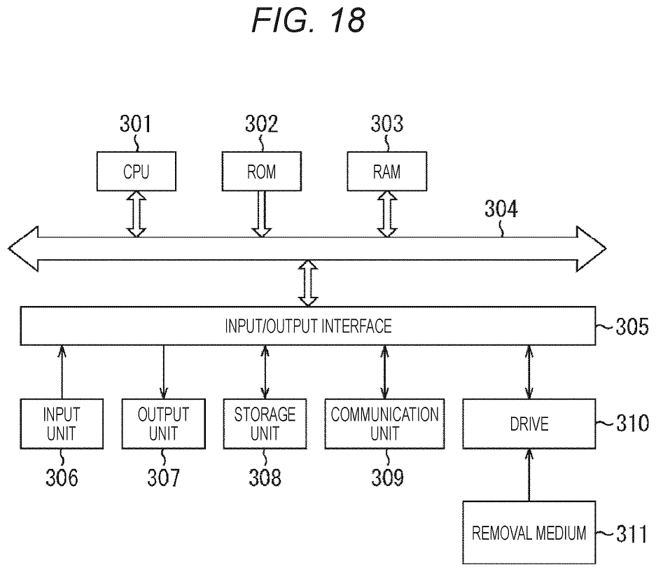

FIG. 18 is a block diagram illustrating a configuration example of the hardware of the computer that executes the series of processing described above in accordance with the program.

A central processing unit (CPU) 301, a read only memory (ROM) 302, and a random access memory (RAM) 303 are connected to one another by a bus 304.

An input/output interface 305 is also connected to the bus 304. An input unit 306 including a keyboard, a mouse, and the like and an output unit 307 including a display, a speaker, and the like are connected to the input/output interface 305. In addition, a storage unit 308 including a hard disk, a nonvolatile memory, and the like, a communication unit 309 including a network interface and the like, and a drive 310 that drives a removable medium 311 are connected to the input/output interface 305.

In the computer configured as described above, the CPU 301 performs the above-described series of processing steps by, for example, loading the program stored in the storage unit 308 into the RAM 303 via the input/output interface 305 and the bus 304 and executing the program.

The program executed by the CPU 301 is stored, for example, in the removable medium 311 and provided or provided through a wired or wireless transmission medium such as a local area network, the Internet, or digital broadcasting, and installed in the storage unit 308.

Note that the program executed by the computer may be a program for performing processing in a time series in order described herein, or may be a program for performing processing in parallel or at necessary timing such as when a call is made.

Note that in the present specification, a system refers to a set of a plurality of components (devices, modules (parts), etc.), and it does not matter whether or not all the components are provided in the same housing. A plurality of devices accommodated in separate housings and linked over a network and one device whose modules are accommodated in one housing are both systems.

In addition, the effects described herein are merely examples and not restrictive, and there may also be other effects.

Embodiments of the present technology are not limited to those described above, and various modifications can be made without departing from the gist of the present technology.

For example, the present technology may be configured as cloud computing in which one function is shared by a plurality of devices over a network and processed in cooperation.

In addition, each step described in the above-described flowcharts may be executed by one device or may be executed by a plurality of devices in a shared manner.

Furthermore, in a case where one step includes a plurality of processing operations, the plurality of processing operations included in the one step may be executed by one device or may be executed by a plurality of devices in a shared manner.

### Examples of Configuration Combinations

The present technology can also be configured as follows.

(1)

A wireless communication device including:
a transmission unit that transmits a first signal to a wireless communication terminal using a first link and a second signal to the wireless communication terminal using a second link; and
a communication control unit that performs, when transmitting the second signal, control in such a way as to include full duplex (FD) communication information, which is information necessary for another wireless communication terminal to perform FD communication using the first link, in the second signal and transmit the FD communication information.

(2)

The wireless communication device according to (1), in which
the FD communication information includes information regarding time length of the first signal.

(3)

The wireless communication device according to (2), in which
the information regarding the time length is included in the FD communication information as information indicating whether or not control for aligning transmission end times between the first link and the second link is being performed.

(4)

The wireless communication device according to any one of (1) to (3), in which
the FD communication information includes information regarding a link with which channel access control for FD communication is performed with the another wireless communication terminal.

(5)

The wireless communication device according to (4), in which
the link with which the channel access control is performed is a third link different from the first link and the second link.

(6)

The wireless communication device according to any one of (1) to (5), in which
the FD communication information includes information regarding the wireless communication terminal and information regarding the another wireless communication terminal capable of FD communication with the wireless communication terminal.

(7)

A wireless communication method used by a wireless communication device, the wireless communication method including:
transmitting a first signal to a wireless communication terminal using a first link and a second signal to the wireless communication terminal using a second link; and
performing, when transmitting the second signal, control in such a way as to include full duplex (FD) communication information, which is information necessary for another wireless communication terminal to perform FD communication using the first link, in the second signal and transmit the FD communication information.

(8)

A wireless communication terminal including:
a communication control unit that obtains, from a signal transmitted from a wireless communication device that performs communication using a first link and a second link, full duplex (FD) communication information, which is information necessary to perform FD communication using the first link, and that controls transmission through the FD communication on a basis of the FD communication information.

(9)

The wireless communication terminal according to (8), in which
the signal includes a first signal transmitted from the wireless communication device to a first another wireless communication terminal using the first link and a second signal transmitted from the wireless communication device to the first another wireless communication terminal using the second link, and
the communication control unit obtains the FD communication information from the second signal among the signals.

(10)

The wireless communication terminal according to (8) or (9), in which
the communication control unit performs control for transmitting a third signal to the wireless communication device through the FD communication using the first link on a basis of the FD communication information during transmission of the first signal by the wireless communication device using the first link.

(11)

The wireless communication terminal according to (10), in which
the communication control unit transmits FD transmission information, which is information regarding the transmission of the third signal through the FD communication using the first link, to a second another wireless communication terminal using a third link on a basis of the FD communication information.

(12)

The wireless communication terminal according to (11), in which
the FD transmission information includes information regarding the first link used for the transmission of the third signal.

(13)

The wireless communication terminal according to (11) or (12), in which
the FD transmission information includes information regarding time length of the transmission of the third signal.

(14)

The wireless communication terminal according to (8) or (9), in which
the communication control unit receives FD transmission information, which is information regarding transmission of a third signal to the wireless communication device through the FD communication using the first link, the FD transmission information being transmitted from a second another wireless communication terminal using a third link, and determines, on a basis of the FD transmission information, whether or not to transmit a fourth signal to the wireless communication device through the FD communication.

(15)

The wireless communication terminal according to (14), in which
the communication control unit determines at least one of time length and a link for transmitting the fourth signal through the FD communication on a basis of the FD transmission information and performs control for transmitting the fourth signal.

(16)

The wireless communication terminal according to (15), in which
the FD transmission information includes information regarding the first link used for the transmission of the third signal.

(17)

The wireless communication terminal according to (15) or (16), in which
the FD transmission information includes information regarding time length of the transmission of the third signal.

(18)

The wireless communication terminal according to any one of (8) to (17), in which
the FD communication information includes information regarding time length of the signal.

(19)

The wireless communication terminal according to (18), in which
the information regarding the time length is included in the FD communication information as information indicating whether or not control for aligning transmission end times between the first link and the second link is being performed.

(20)

The wireless communication terminal according to any one of (11) to (19), in which
the FD communication information includes information regarding a link with which channel access control for FD communication is performed with the second another wireless communication terminal.

(21)

A wireless communication method used by a wireless communication device, the wireless communication method including:

obtaining, from a signal transmitted from a wireless communication device that performs communication using a first link and a second link, full duplex (FD) communication information, which is information necessary to perform FD communication using the first link, and controlling transmission through the FD communication on a basis of the FD communication information.

### REFERENCE SIGNS LIST

11 Wireless communication device
31 Communication unit
41 Antenna
51 Switching section
52 Transmission amplification section
53 Reception amplification section
54 Transmission wireless interface section
55 Reception wireless interface section
56 Transmission signal processing section
57 Reception signal processing section
58 Individual data processing section
59 Common data processing section
60 Communication control section
61 Communication storage section
71 Wireless communication device
81 Communication unit
91, 92, 93 Self-interference cancellation section

1. A wireless communication device comprising:
a transmission unit that transmits a first signal to a wireless communication terminal using a first link and a second signal to the wireless communication terminal using a second link; and
a communication control unit that performs, when transmitting the second signal, control in such a way as to include full duplex (FD) communication information, which is information necessary for another wireless communication terminal to perform FD communication using the first link, in the second signal and transmit the FD communication information.

2. The wireless communication device according to claim 1, wherein
the FD communication information includes information regarding time length of the first signal.

3. The wireless communication device according to claim 2, wherein
the information regarding the time length is included in the FD communication information as information indicating whether or not control for aligning transmission end times between the first link and the second link is being performed.

4. The wireless communication device according to claim 1, wherein
the FD communication information includes information regarding a link with which channel access control for FD communication is performed with the another wireless communication terminal.

5. The wireless communication device according to claim 4, wherein
the link with which the channel access control is performed is a third link different from the first link and the second link.

6. The wireless communication device according to claim 1, wherein
the FD communication information includes information regarding the wireless communication terminal and information regarding the another wireless communication terminal capable of FD communication with the wireless communication terminal.

7. A wireless communication method used by a wireless communication device, the wireless communication method comprising:
transmitting a first signal to a wireless communication terminal using a first link and a second signal to the wireless communication terminal using a second link; and
performing, when transmitting the second signal, control in such a way as to include full duplex (FD) communication information, which is information necessary for another wireless communication terminal to perform FD communication using the first link, in the second signal and transmit the FD communication information.

8. A wireless communication terminal comprising:
a communication control unit that obtains, from a signal transmitted from a wireless communication device that performs communication using a first link and a second link, full duplex (FD) communication information, which is information necessary to perform FD communication using the first link, and that controls transmission through the FD communication on a basis of the FD communication information.

9. The wireless communication terminal according to claim 8, wherein
the signal includes a first signal transmitted from the wireless communication device to a first another wireless communication terminal using the first link and a second signal transmitted from the wireless communication device to the first another wireless communication terminal using the second link, and
the communication control unit obtains the FD communication information from the second signal among the signals.

10. The wireless communication terminal according to claim 8, wherein
the communication control unit performs control for transmitting a third signal to the wireless communication device through the FD communication using the first link on a basis of the FD communication information during transmission of the signal by the wireless communication device using the first link.

11. The wireless communication terminal according to claim 10, wherein
the communication control unit transmits FD transmission information, which is information regarding the transmission of the third signal through the FD communication using the first link, to a second another wireless communication terminal using a third link on a basis of the FD communication information.

12. The wireless communication terminal according to claim 11, wherein
the FD transmission information includes information regarding the first link used for the transmission of the third signal.

13. The wireless communication terminal according to claim 11, wherein
the FD transmission information includes information regarding time length of the transmission of the third signal.

14. The wireless communication terminal according to claim 8, wherein
the communication control unit receives FD transmission information, which is information regarding transmission of a third signal to the wireless communication device through the FD communication using the first link, the FD transmission information being transmitted from a second another wireless communication terminal using a third link, and determines, on a basis of the FD transmission information, whether or not to transmit a fourth signal to the wireless communication device through the FD communication.

15. The wireless communication terminal according to claim 14, wherein
the communication control unit determines at least one of time length and a link for transmitting the fourth signal through the FD communication on a basis of the FD transmission information and performs control for transmitting the fourth signal.

16. The wireless communication terminal according to claim 15, wherein
the FD transmission information includes information regarding the first link used for the transmission of the third signal.

17. The wireless communication terminal according to claim 15, wherein
the FD transmission information includes information regarding time length of the transmission of the third signal.

18. The wireless communication terminal according to claim 8, wherein
the FD communication information includes information regarding time length of the signal.

19. The wireless communication terminal according to claim 18, wherein
the information regarding the time length is included in the FD communication information as information indicating whether or not control for aligning transmission end times between the first link and the second link is being performed.

20. The wireless communication terminal according to claim 11, wherein
the FD communication information includes information regarding a link with which channel access control for FD communication is performed with the second another wireless communication terminal.
